(19) United States
(12) Patent Application Publication
(10) Pub. No.: US 2007/0162349 A1
(43) Pub. Date: Jul. 12, 2007

(54) Client Side Brand Protection

(75) Inventor: David Silver, Sparks, NV (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MarkMonitor Inc., Boise, ID (US)

(21) Appl. No.: 11/550,219

(22) Filed: Oct. 17, 2006

Related U.S. Application Data
(60) Provisional application No. 60/727,891, filed on Oct. 17, 2005.

(51) Int. Cl. G06Q 30/00

(52) U.S. Cl. 705/26

(57) ABSTRACT

Embodiments of the invention provide systems and methods for providing authentication of brand information used on a website. According to one embodiment, providing reputation based authentication of brand information can comprise collecting information related to each of a plurality of websites. The information can relate to use of brand information by the website. Information related to the website from the collected information can be correlated and scored based on the correlated data. According to another embodiment, reputation information related to the website can be requested from a reputation service. The reputation information can comprise a score indicating the relative authenticity of the brand information used by the website. The reputation information can be received from the reputation service and an indication of the authenticity of the brand information used by the website can be generated based on the score.

### CROSS-REFERENCES TO RELATED APPLICATIONS

This application claims the benefit of U.S. Provisional Application No. 60/727,891, filed Oct. 17, 2005 by Silver and entitled “Client Side Brand Protection,” the entire disclosure of which is incorporated herein by reference.

This application is also related to the following commonly-owned, co-pending applications (the “Related Applications”), of which the entire disclosure of each is incorporated by reference:

U.S. patent application Ser. No. 10/709,398, filed May 2, 2004, by Shraim et al. and entitled “Online Fraud Solution”; U.S. Provisional Application No. 60/615,973, filed Oct. 4, 2004, by Shraim et al. and entitled “Online Fraud Solution”; U.S. Provisional Application No. 60/610,714, filed Sep. 17, 2004, by Shull and entitled “Methods And Systems For Preventing Online Fraud”; U.S. Provisional Application No., 60/610,715, filed Sep. 17, 2004, by Shull and entitled “Customer-Based Detection Of Online Fraud”; U.S. patent application Ser. No. 10/996,991, filed Nov. 23, 2004, by Shraim et al. and entitled “Online Fraud Solution”; U.S. patent application Ser. No. 10/996,567, filed Nov. 23, 2004, by Shull et al. and entitled “Enhanced Responses To Online Fraud”; U.S. patent application Ser. No. 10/996,990, filed Nov. 23, 2004, by Shull et al. and entitled “Customer-Based Detection Of Online Fraud”; U.S. patent application Ser. No. 10/996,566, filed Nov. 23, 2004, by Shull et al. and entitled “Early Detection Of Online Fraud”; U.S. patent application Ser. No. 10/996,646, filed Nov. 23, 2004, by Shull et al. and entitled “Enhanced Responses To Online Fraud”; U.S. patent application Ser. No. 10/996,568, filed Nov. 23, 2004, by Shull et al. and entitled “Generating Phish Messages”; U.S. patent application Ser. No. 10/997,626, filed Nov. 23, 2004, by Shull et al. and entitled “Methods And Systems For Analyzing Data Related To Possible Online Fraud”; U.S. Provisional Application No. 60/658,124, filed Mar. 2, 2005, by Shull et al. and entitled “Distribution Of Trust Data”; U.S. Provisional Application No. 60/658,087, filed Mar. 2, 2005, by Shull et al. and entitled “Trust Evaluation System And Methods”; and U.S. Provisional Application No. 60/658,281, filed Mar. 2, 2005, by Shull et al. and entitled “Implementing Trust Policies.”

### BACKGROUND OF THE INVENTION

Embodiments of the present invention relate generally to preventing online fraud. More particularly, embodiments of the present invention relate to protecting brands and other intellectual property.

Internet domain registrations have long been known and widely used for entities to provide a virtual means to find and locate an entity for the purpose of either information exchange or transacting business. The process of registration includes identification of information related to a location of the entity. For example, contact information is provided during the registration process for the entity registering a domain name. However, the registration process does not include or utilize proof of ownership of any trademark or brand, or other intellectual property used on the registered website. Nor does it include regulations or restrictions of information that can be distributed via the site. As a result of the lack of connection that exists between registration of a domain and how the domain is actually used in practice, there has been and will continue to be both authorized and unauthorized use of other individuals identities, reputations, and intellectual properties. Hence, there is a need in the art for methods and systems that provide for the mapping of Internet ownership coupled with identifying events/behaviors occurring on these domains that one can gain understanding of both authorized and unauthorized usage of a company's trademarks, brand names, and other intellectual property.

### BRIEF SUMMARY OF THE INVENTION

Embodiments of the invention provide systems and methods for providing authentication of brand information used on a website. According to one embodiment, a method for providing reputation based authentication of brand information used by a website can comprise collecting information related to each of a plurality of websites. The information can relate to use of brand information by the website. Information related to the website from the collected information can be correlated. The use of the brand information by the website can be scored based on the correlated data.

According to another embodiment, a method of determining authenticity of brand information used by a website can comprise requesting reputation information related to the website from a reputation service. The reputation information can comprise a score indicating the relative authenticity of the brand information used by the website. The reputation information can be received from the reputation service and an indication of the authenticity of the brand information used by the website can be generated based on the score.

According to yet another embodiment, a system can comprise a communications network and a reputation service communicatively coupled with the communications network. The reputation service can be adapted to collect information related to each of a plurality of websites, the information related to use of brand information by each of the websites, correlate information related to a website from the collected information, and score the use of the brand information by the website based on the correlated data. The system can also include a client system communicatively coupled with the communications network. The client system can be adapted to request reputation information related to the website from the reputation service, receive the reputation information from the reputation service and generating an indication of the authenticity of the brand information used by the website based on the score.

### BRIEF DESCRIPTION OF THE DRAWINGS

FIG. 1 is a block diagram illustrating a system for delivering information related to authorized and unauthorized use of brand information according to one embodiment of the present invention.

FIG. 2 is a block diagram illustrating an exemplary computer system upon which embodiments of the present invention can be implemented.

FIG. 3 illustrates sources for reputation based identities according to one embodiment of the present invention.

FIG. 4 illustrates creating authorized/unauthorized brand ownership information according to one embodiment of the present invention.

FIG. 5 illustrates a client side policy engine according to one embodiment of the present invention.

FIG. 6 illustrates updating an identity based brand reputation cache according to one embodiment of the present invention.

FIG. 7 illustrates reputation based brand authentication according to one embodiment of the present invention.

FIG. 8 is a flowchart illustrating a process for providing a brand reputation service according to one embodiment of the present invention.

FIG. 9 is a flowchart illustrating a process for a client interaction with a brand reputation service according to one embodiment of the present invention.

FIG. 10 is a flowchart illustrating a process for a client interaction with a brand reputation service according to an alternative embodiment of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Generally speaking, embodiments of the present invention relate to delivering information related to authorized and unauthorized use of brand information. The information related to authorized and unauthorized use of brand information can be derived by combining mapping of Internet ownership and identifying events/behaviors occurring on these domains to build a reputational-identity based source of information that can then be used for delivering authorized and unauthorized ownership/brand usage information.

Various embodiments of the present invention described herein relate to the distribution of this collected information out to a client side application such that consumers can adequately discern between legitimate providers of information or products versus illegitimate providers. Embodiments of the present invention include a service based interface that connects to the combined data such that the reporting of authorized or unauthorized brand usage can be provided to the client application including applications such as Internet browsers, toolbars, transaction base applications, etc. The client can be provided with varying degrees of confidence of the brand or reputation of the site they are accessing. This confidence can span anywhere from the source being an authorized and trusted source to represent the trademark or brand and subsequently provides the confidence of goods being obtained is trusted, all the way to the other end of the spectrum which would include the ability to inform the client of fraudulent and unauthorized usage of the trademark/brand. According to one embodiment of the present invention, warnings and/or alerts can be provided that allow the user to make an informed decision as to how/if they desire to proceed.

Various embodiments of the present invention provide Internet domain ownership information combined with brand/trademark ownership information such that the combined data can be used to deliver ratings associated with use of brand information by a website for use in validating client side identification and consumer protection services of authorized and/or unauthorized Internet sites representing themselves as authorized distributors.

Various embodiments of the present invention provide for the delivery of reputational-based identity information to a client desktop application including, but not limited to, an Internet browser, toolbar or client-side application. One embodiment of the present invention provides for the protection of electronically transmitted brand, intellectual property and trademark rights for corporations. Another embodiment provides a mechanism for alerting consumers as to whether they have established and are interacting with a legitimate and/or authorized seller of a company sponsored brand. Yet another embodiment provides for the confirmation that the consumer is accessing, making a purchase, and/or receiving information from the company or an authorized reseller of the company, as well as an indication of accessing information or conducting a transaction from unauthorized, or non-genuine representation of a brand and the associated product(s).

Still another embodiment provides an information delivery mechanism providing confirmation of interacting with a brand or an affiliate such that the determination of genuine vs. non-genuine goods or information can be accessed. According to one embodiment, a reputation-based communication channel can be provided between the corporation and the consumer such that the consumer can be alerted to the authenticity of goods either received as information or purchased.

Yet another embodiment of the present invention provides a master database, centralized or distributed, combining Internet domain ownership data with brand ownership information. This information can be callable by client applications including, but not limited to, of Internet Browser technologies, tool bars, and other applications such that varying degrees of insight as to the authenticity of the supplier can be validated.

According to another embodiment, the information feed accessed by client side applications can provide understanding of not only unauthorized domains that have misappropriated another's brand or trademark rights, but can also provide confirmation of valid ownership. The information can also be used to provide territorial based limitations of usage associated with brand based purchases or information dissemination.

It should be noted that, while discussed herein with reference to brand names and/or trademarks, embodiments of the present invention are not necessarily so limited. That is, embodiments of the present invention can be adapted and/or implemented to monitor and provide information related to any type of name or mark, whether registered or common, or other identifier associated with a company or other entity. Thus, as used herein, the terms name, brand, trademark, etc. are intended to refer to any identifier or other intellectual property associated with a particular entity.

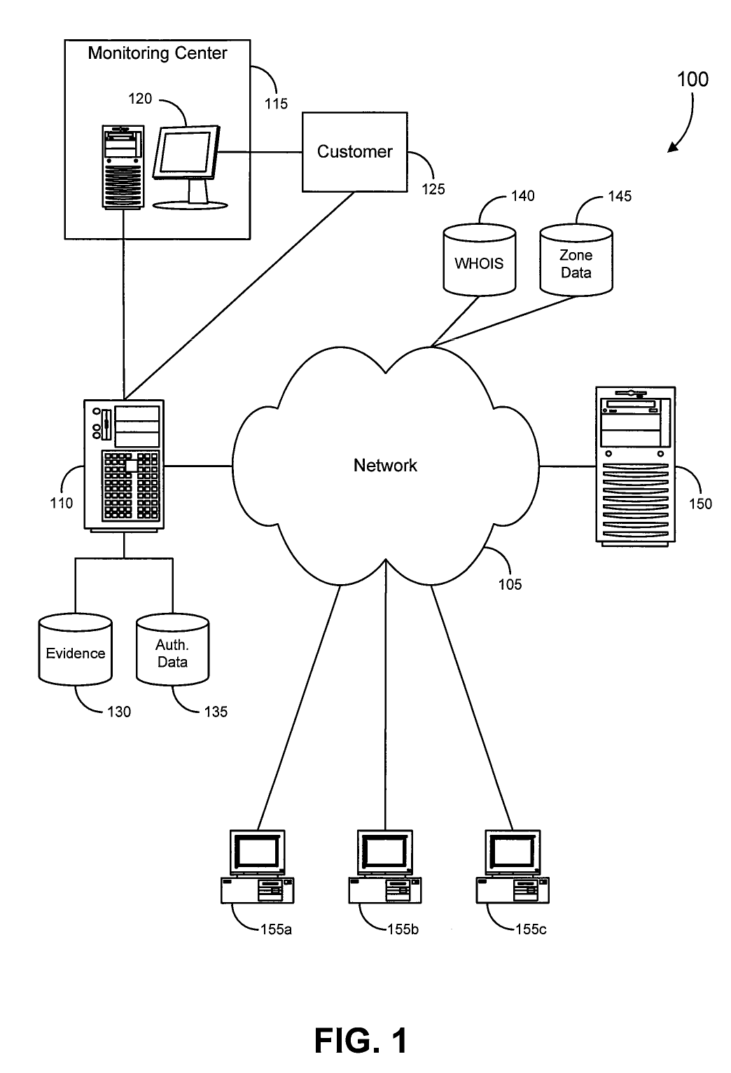

FIG. 1 is a block diagram illustrating a system for delivering information related to authorized and unauthorized use of brand information according to one embodiment of the present invention. The system 100 of FIG. 1 can be considered exemplary of one set of embodiments. The system 100 generally runs in a networked environment, which can include a network 105. In many cases, the network 105 will be the Internet, although in some embodiments, the network 105 may be some other public and/or private network. In general, any network capable of supporting data communications between computers will suffice. The system 100 includes a master computer 110, which can be used to perform any of the procedures or methods discussed herein. In particular, the master computer 110 can be configured (e.g., via a software application) to crawl and/or monitor various data sources such as those described below, and/or communicate with a monitoring center 115 (and, more particularly, with a monitoring computer 120 within the monitoring center) e.g. via a telecommunication link. The master computer 110 may be a plurality of computers, and each of the plurality of computers may be configured to perform specific processes in accordance with various embodiments. Merely by way of example, one computer may be configured to monitor and/or communicate with various data sources such as those described below, another computer may be configured to execute software associated with a correlation engine, e.g. performing the analysis of the collected data; a third computer may be configured to serve as an event manager, e.g., investigating and/or responding to incidents of suspected misuse of brand information, and/or a fourth computer may be configured to act as a dilution engine, e.g., to generate and/or transmit a technical response, which may comprise, merely by way of example, one or more HTTP requests, as described in further detail below. Likewise, the monitoring computer 120 may be configured to perform any appropriate functions.

The monitoring center 115, the monitoring computer 120, and/or the master computer 110 may be in communication with one or more customers 125 e.g., via a telecommunication link, which can comprise connection via any medium capable of providing voice and/or data communication, such as a telephone line, wireless connection, wide area network, local area network, virtual private network, and/or the like. Such communications may be data communications and/or voice communications (e.g., a technician at the monitoring center can conduct telephone communications with a person at the customer). Communications with the customer(s) 125 can include transmission of an event report, notification of an event, and/or consultation with respect to responses to misuse of brand or other information associated with or monitored by or on behalf of an entity. According to one embodiment of the present invention, communications between the customer(s) 125 and the monitoring center 115 can comprise a web browser of the customer computer requesting information regarding a requested or viewed page in order to determine whether misuse of brand information is associated with that page.

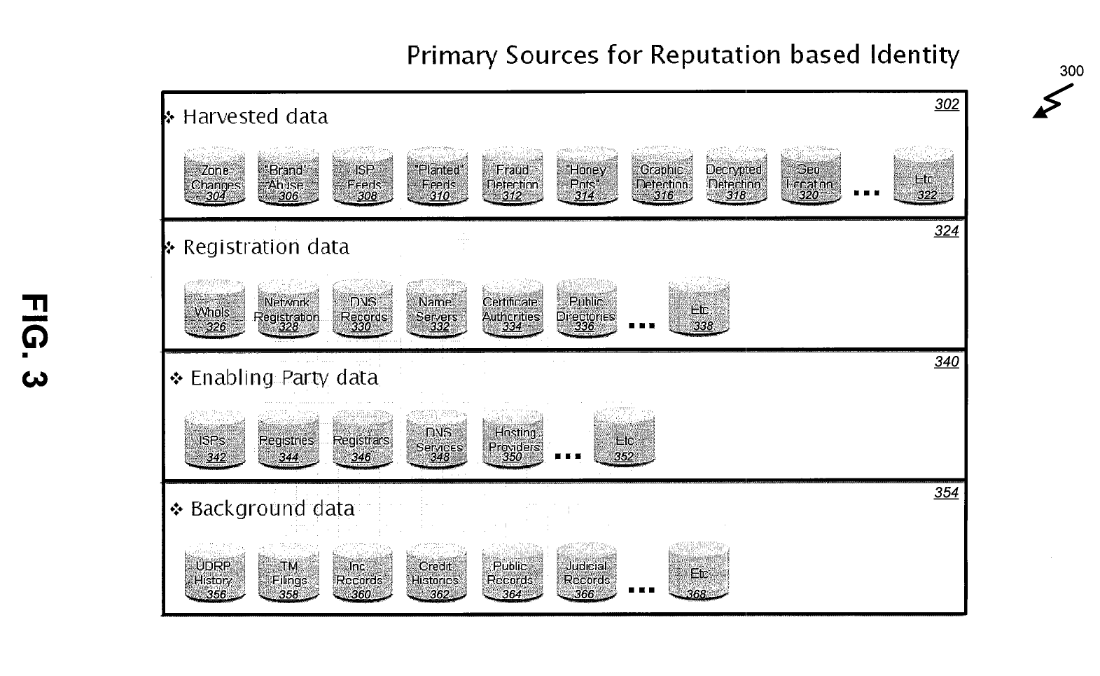

The master computer 110 can include (and/or be in communication with) a plurality of data sources, including without limitation the data sources described below with reference to FIG. 3. Other data sources may be used as well. For example, the master computer can comprise an evidence database 130 and/or a database of “authorized data,” 135, which can be used to identify sites known to be associated with authorized uses of brand information. (As used herein, the term “database” should be interpreted broadly to include any means of storing data, including traditional database management software, operating system file systems, and/or the like.) The master computer 110 can also be in communication with one or more sources of information about the Internet and/or any servers to be investigated. Such sources of information can include a domain WHOIS database 140, zone data file 145, etc. Those skilled in the art will appreciate that WHOIS databases often are maintained by central registration authorities (e.g., the American Registry for Internet Numbers (“ARIN”), Network Solutions, Inc., etc), and the master computer 110 can be configured to query those authorities; alternatively, the master computer 110 could be configured to obtain such information from other sources, such as privately-maintained databases, etc. The master computer 110 (and/or any other appropriate system component) may use these resources, and others, such as publicly-available domain name server (DNS) data, routing data and/or the like, to investigate a server 150 suspected of unauthorized uses of brand information. As noted above, the server 150 can be any computer capable of processing online transactions, serving web pages and/or otherwise collecting personal information.

The system can also include one or more response computers 155, which can be used to provide a technical response to unauthorized use of brand information. (It should be noted that the functions of the response computers 155 can also be performed by the master computer 110, monitoring computer 120, etc.) In particular embodiments, a plurality of computers (e.g., 155a-c) can be used to provide a distributed response. The response computers 155, as well as the master computer 110 and/or the monitoring computer 120, can be special-purpose computers with hardware, firmware and/or software instructions for performing the necessary tasks. Alternatively, these computers 110, 120, 155 may be general purpose computers having an operating system including, for example, personal computers and/or laptop computers running any appropriate flavor of Microsoft Corp.'s Windows and/or Apple Corp.'s Macintosh operating systems) and/or workstation computers running any of a variety of commercially-available UNIX or UNIX-like operating systems. In particular embodiments, the computers 110, 120, 155 can run any of a variety of free operating systems such as GNU/Linux, FreeBSD, etc.

The computers 110, 120, 155 can also run a variety of server applications, including HTTP servers, FTP servers, CGI servers, database servers, Java servers, and the like. These computers can be one or more general purpose computers capable of executing programs or scripts in response to requests from and/or interaction with other computers, including without limitation web applications. Such applications can be implemented as one or more scripts or programs written in any programming language, including merely by way of example, C, C++, Java, COBOL, or any scripting language, such as Perl, Python, or TCL, or any combination thereof. The computers 110, 120, 155 can also include database server software, including without limitation packages commercially available from Oracle, Microsoft, Sybase, IBM and the like, which can process requests from database clients running locally and/or on other computers. Merely by way of example, the master computer 110 can be an Intel processor-machine operating the GNU/Linux operating system and the PostgreSQL database engine, configured to run proprietary application software for performing tasks in accordance with embodiments of the invention.

In some embodiments, one or more computers 110 can create web pages dynamically as necessary for displaying investigation reports, etc. These web pages can serve as an interface between one computer (e.g., the master computer 110) and another (e.g., the monitoring computer 120). Alternatively, a computer (e.g., the master computer 110) may run a server application, while another (e.g., the monitoring computer 120) device can run a dedicated client application. The server application, therefore, can serve as an interface for the user device running the client application. Alternatively, certain of the computers may be configured as “thin clients” or terminals in communication with other computers.

The system 100 can include one or more data stores, which can comprise one or more hard drives, etc. and which can be used to store, for example, databases (e.g., 130, 135) The location of the data stores is discretionary. Merely by way of example, they can reside on a storage medium local to (and/or resident in) one or more of the computers. Alternatively, they can be remote from any or all of these devices, so long as they are in communication (e.g., via the network 105) with one or more of these. In some embodiments, the data stores can reside in a storage-area network (“SAN”) familiar to those skilled in the art. (Likewise, any necessary files for performing the functions attributed to the computers 110, 120, 155 can be stored a computer-readable storage medium local to and/or remote from the respective computer, as appropriate.)

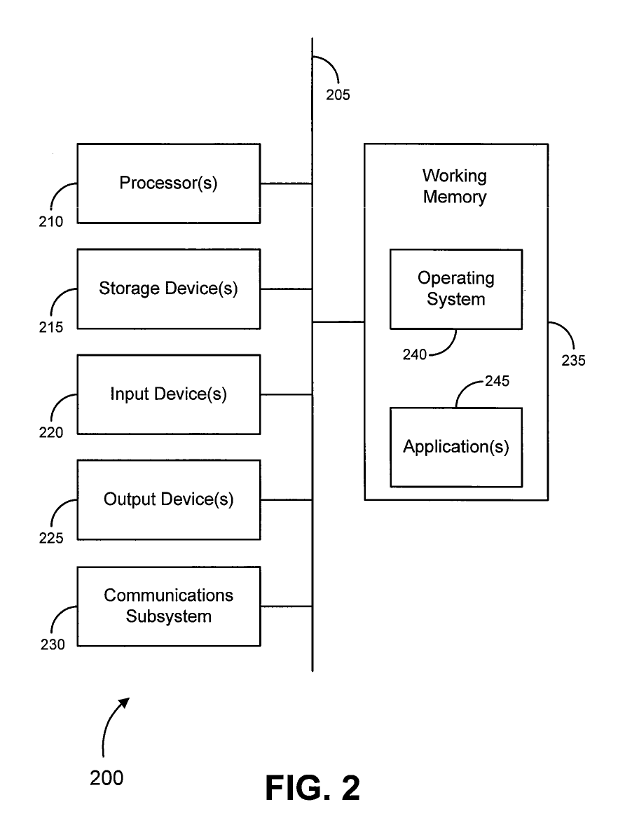

FIG. 2 is a block diagram illustrating an exemplary computer system upon which embodiments of the present invention can be implemented. FIG. 2 provides a generalized schematic illustration of one embodiment of a computer system 200 that can perform the methods of the invention and/or the functions of a master computer, monitoring computer and/or response computer, as described herein. FIG. 2 is meant only to provide a generalized illustration of various components, any of which may be utilized as appropriate. The computer system 200 can include hardware components that can be coupled electrically via a bus 205, including one or more processors 210; one or more storage devices 215, which can include without limitation a disk drive, an optical storage device, solid-state storage device such as a random access memory (“RAM”) and/or a read-only memory (“ROM”), which can be programmable, flash-updateable and/or the like (and which can function as a data store, as described above). Also in communication with the bus 205 can be one or more input devices 220, which can include without limitation a mouse, a keyboard and/or the like; one or more output devices 225, which can include without limitation a display device, a printer and/or the like; and a communications subsystem 230; which can include without limitation a modem, a network card (wireless or wired), an infra-red communication device, and/or the like).

The computer system 200 also can comprise software elements, shown as being currently located within a working memory 235, including an operating system 240 and/or other code 245, such as an application program as described above and/or designed to implement methods of the invention. Those skilled in the art will appreciate that substantial variations may be made in accordance with specific embodiments and/or requirements. For example, customized hardware might also be used, and/or particular elements might be implemented in hardware, software (including portable software, such as applets), or both.

According to one embodiment of the present invention, data related to a brand or other intellectual property of an entity can be collected, aggregated, correlated and stored in a centralized or distributed repository of a reputation service or system such as system 100 as described above with reference to FIG. 1. This information can then be scored by the system 100 by comparing and combining information associated with domain registration ownership and brand usage/activity associated with the domain. This brand usage and activity can be found in the registration name itself, email sending activity, website information, etc. The information can then be delivered by a distributed architecture allowing client side applications including web browsers, email clients, tool bars, application, etc. to request scored information. The client application can then process the acquired score such that confidence levels can be delivered indicating varying degrees of brand use/abuse. This information can be used to confirm valid/trusted/genuine brand usage, as well as misappropriated or fraudulent activities. Examples of usage can include, but are not limited to, helping the client side consumer to determine whether they are interacting with a trusted party or one of the parties affiliates. Additionally, the solution can be used as a vehicle to describe potential fraudulent sites, potential fraudulent transactions, unauthorized distributors, non-genuine products, etc.

FIG. 3 illustrates sources for reputation based identities according to one embodiment of the present invention. These sources can include, but are not limited to, harvested data 302, registration data 324, enabling party data 340, and background data 354. Information from these sources 300 can be collected by a system such as system 100 described above or a similar system. In some cases, the information can be collected in accordance with the methods described in the Related Applications cited above.

According to one embodiment, harvested data 302 represents information that can be harvested from various sources including but not limited to zone files 304, ISP feeds 308, and web search brand usage or abuse information 306 collected from various Internet service providers and/or other sources as described, for example, in the Related Applications by the system 100 and stored in the repository. Harvested data 302 can also include information related to “planted” feeds 310, fraud detection 312 related to particular websites, and one or more “honey pots” 314 of information each of which can be collected, for example, as described in the Related Applications. The harvested data 302 can additional or alternatively include graphic detection information 316 related to logos or other graphics identified on particular websites and/or associated with particular entities, decrypted detection information 318 related to particular websites and/or associated with particular entities that was or is originally encrypted, and/or geo-location information 320 related to a physical location of a server providing a website. Various other information 322 from any of a number of sources may also be included in the harvested data 302.

Registration data 324 represents information collected by the system 100 from any of a number of sources related to website registration. For example, registration data can include “whois” registration information 326, historic network registration records 328, and DNS records 330 obtained as described above and/or in the Related Applications. The registration information 324 can additionally or alternatively include information from one or more name servers 332, certificate authorities 334, public directories 336 and other 338 sources.

Enabling party data 340 can include, for example, information from ISPs 342, and various registry 344 and/or registrar 346 services and collected by the system 100. The enabling party data 340 can additionally or alternatively include information from DNS services 348, hosting providers 350 and other services 352 collected by the system 100 from the appropriate online or other electronic sources.

Background data 354 can include, but is not limited to, UDRP case information 356, trademark registration data 358, incorporation records 360, credit histories 362, various public records 364, judicial records 366, and other 368 possible information collected by the system 100 from various public or private records or services.

This information 300 can be collected, updated and stored, to build a master record that ties ownership rights with brand information usage. The information can be maintained in a central location. The data collected can then be used for the next step in the process that focuses on correlating this information for the purpose of creating an understanding of authorized and unauthorized ownership and usage of brands.

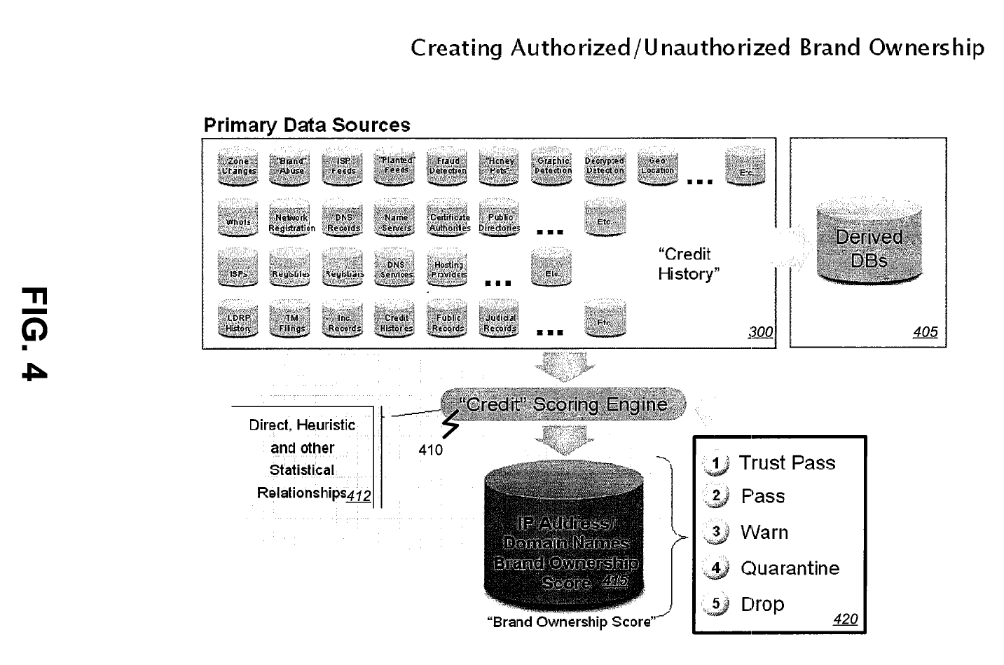

Generally speaking, the collected and correlated data can then be further processed creating a “credit score” type strategy that uses algorithms that bring together and synthesize domain ownership, brand rights, and brand usage events. FIG. 4 illustrates creating authorized/unauthorized brand ownership information according to one embodiment of the present invention. This example illustrates the collections of data 300 as described above with reference to FIG. 3. Furthermore, one or more derived databases 405 can be generated from the collections of data 300. For example, the derived databases 405 can include information indicating identified unauthorized or misuses of brand information. Additionally or alternatively, the derived databases 405 can include information indicating identified authorized or legitimate uses of brand information.

The collection of information 300 and possibly information from the derived databases 405 can then be scored across multiple vectors by the scoring engine 410. That is, the scoring engine 410 can provide a confidence level scoring mechanisms such that probabilities and relationships can be determined with regards to IP addresses, URLs and authorized/unauthorized brand rights as well as historical brand usage event activities.

According to one embodiment, this information can further be correlated with geographic information such that an understanding of where valid/invalid usages are allowed territorially. The collected information 300 can be processed through a huristic and statistical modeling process 412 of the scoring engine 410 creating a brand-identity-reputation score 415. For example, the score may be represented as a raw number representing the relative likelihood of a legitimate or authorized use of a mark or brand name. According to one embodiment, the score can be represent as a number of levels 420, such as “trust pass”, “pass”, “warn”, “quarantine”, “drop”, etc. that can be used to represent the relative likelihood of a legitimate or authorized use of a mark or brand name and possibly an action to be taken for a particular result. Regardless of the exact format of the score, the score can then be used to determine where authorized/unauthorized brand activities are occurring, and helps further identity and determine a protection, and security protection mechanism to make the Internet safe for corporations and their customers.

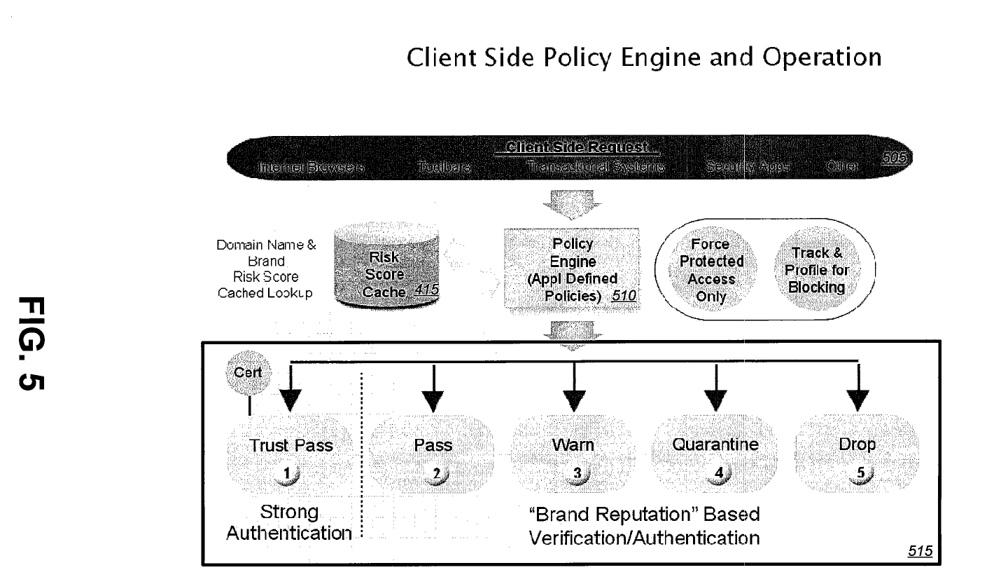

According to one embodiment, this score information, once generated, can then be made available to client side applications, for example, via a service based API. FIG. 5 illustrates a client side policy engine according to one embodiment of the present invention. More specifically, FIG. 5 illustrates a policy engine 510 can be stored on and/or executed by a client computer. According to one embodiment, the policy engine 510 can provide an API to allow other client application such as a web browser, toolbars, security applications, etc., to make requests 505 for the score of a particular website or sites.

The API or other interface of the policy engine 510 can provide a callable interface that allows a client application to request and receive the derived score for a website. The policy engine can in turn request the score for the website designated by the requesting application from the risk score cache 415. This score can be processed by the policy engine 510 to determine how the information is to be used. As an example, Internet browser technologies and toolbars can be used to alert users of these technologies of valid sites that have valid distribution rights of products or information. For example, the policy engine may provide to the requesting application one of a plurality of levels of indications 515 related to the validity or legitimacy of the website as indicated by the risk score. For example, the indications 515 include levels such as “trust pass”, “pass”, “warn”, “quarantine”, “drop”, etc. that can be used to represent the relative likelihood of a legitimate or authorized use of a mark or brand name and possibly an action to be taken by the requesting application.

The brand based reputational-identity score can be used to determine authorized versus unauthorized ownership and usage, and can be used by client applications inclusive of transactional validation, proof of genuine distribution rights, and limiting out of territory distribution. Additionally, the invention helps companies minimize brand erosion issues, and helps to reduce the impact of gray and black-market activities.

According to one embodiment of the present invention, not only a score can be delivered, but customized messages can be delivered by the policy engine 510 as part of the score. These messages can include warnings to unsuspecting consumers who believe they are purchasing genuine or authorized goods, as well as provide positive messages such that confirmation of the purchase of genuine or authentic goods or information is coming from a trusted source. Pre-created scores and score banding can be provided, as well as the flexibility to customize the meaning of scores or score bands.

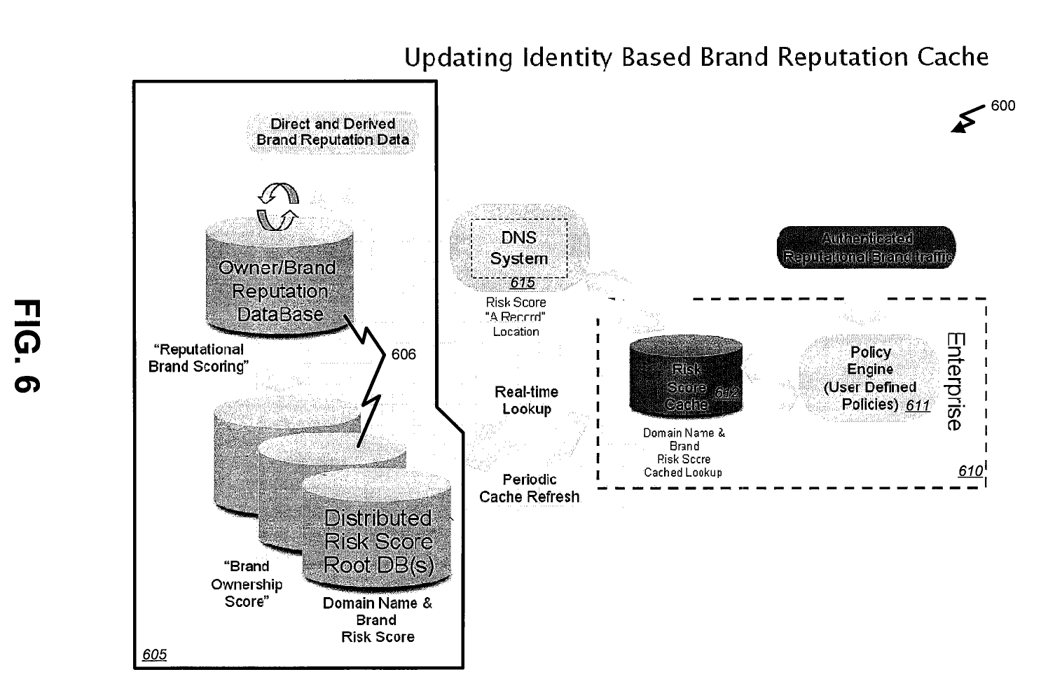

The Identity based brand reputation service can be deliverable either as a centralized service based API, or can be distributed across a caching based approach such as illustrated in FIG. 6. That is, rather than a client side policy engine that responds to request from other client applications by requesting and receiving a score for a particular website from a reputation service as described above with reference to FIG. 5, the reputation service may periodically distribute reputation information to be cached on the client. The cached approach would allow for the information to be distributable as part of a domain ownership record that can be processed at the same speed of a DNS lookup. The client application could either make an API call to the centralized service, or leverage the cache.

FIG. 6 illustrates updating an identity based brand reputation cache according to one embodiment of the present invention. In this example, the policy engine 611 can request a periodic update or cache refresh from the reputation service 605. The reputation service 605 can then provide results representing a set or subset of the reputation data maintained in its databases 606. The set or subset provided to the client based policy engine can depend on any of a number of factors including a service agreement between the client and the service, data updated since the client last requested a cache up[date, or any of a number of other possible criteria.

A client application, such as a web browser, can make the request to the score from the policy engine 610, along with other potential attributes including messages, and brand ownership information. For example, the request can be made in response or in addition to a request to the DNS system 615. The policy engine can then retrieve a pre-stored score from the local risk score cache 612 for answering the request. Alternatively, if no pre-stored score for the web page is present in the local risk store cache, the policy engine 611 can make a real-time lookup request for the score to the reputation service 605. In such a case, the policy engine 611 can be adapted to store the returned score in the local risk score cache 612 for later use.

According to an alternative embodiment, predefined reputation bands can also be leveraged for those clients that may not have a policy engine in place, but require a standardized scoring mechanism for determining domain ownership/brand ownership and identity rights. In such cases, the local risk score cache 612 may be adapted to periodically receive the bands or levels for a set or subset of web pages from the reputation service 605. The local risk score cache 612 may then be directly accessed by the client applications rather than by the applications requesting the scored via the policy engine 611.

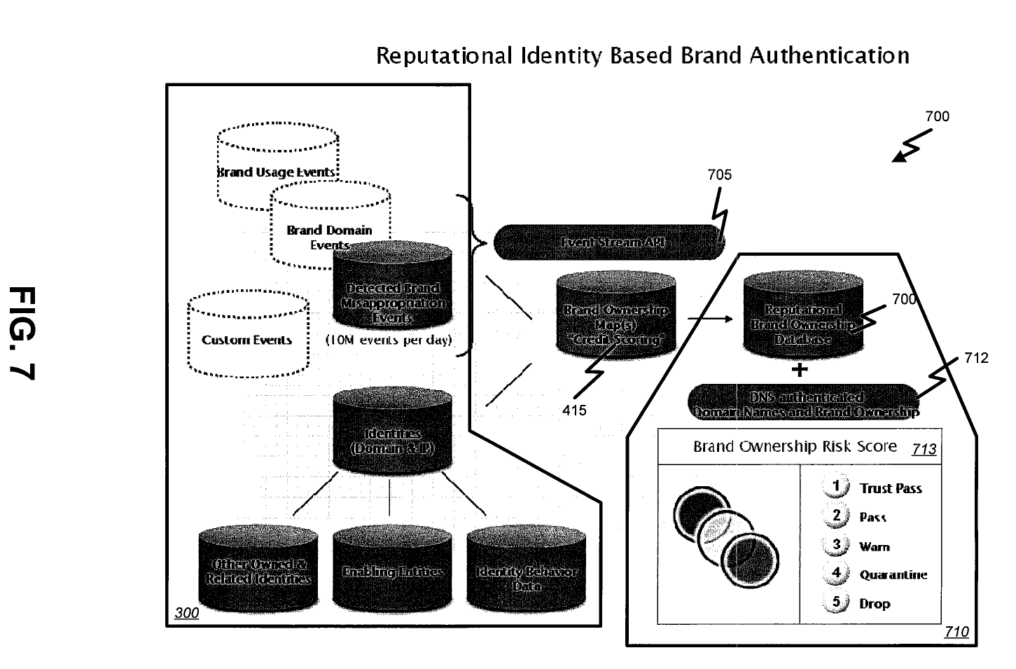

According to one embodiment, the system can allow for client applications to provide visual cues as well as messages to help the recipient determine the risk level of interacting with a suspected companies brand. FIG. 7 illustrates providing reputation based brand authentication indications according to one embodiment of the present invention. In this example and as described above, a client 710 can request score information from a reputation service 300 in real-time or periodically. The request can be made via an API 705 or other interface. The service 300 can provide the score information 415 to the client 710, perhaps to be stored in a local score cache 711. Upon request for a DNS service 712 the client can retrieve to score from the local cache 711 or from the service 300 and reply to the application with score information 713. The score information can be provided in the form of warnings, blocking, or application specific processing that allows for the indication of authorized or unauthorized brand usage. That is, the score information 713 provided to the requesting application can be in the form of one of a plurality of levels, wherein each level of the plurality of levels represents a relative level of authenticity or legitimacy for the website. Alternatively or additionally, a flag or other indicator such a red, yellow, green, level indicator may be provided. Alternatively or additionally, any of a number of messages or warnings may be provided based on the score and the policies of the policy engine.

Therefore, embodiments of the present invention provide a vehicle for client side applications to provide protection or warning services that can bring together domain ownership rights, identity rights, territory distribution rights, and brand ownership such that the appropriate actions can be taken based on the policies of the policy engine and the score for the website. Embodiments of the present invention provide intellectual property owners with a mechanism for protecting their brand integrity while at the same time helping their customers feel safe in using the internet as a fundamental channel for both communicating and doing business.

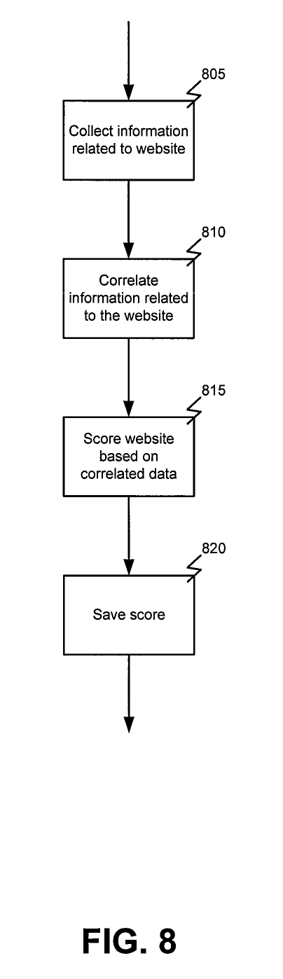

FIG.8 is a flowchart illustrating a process for proving a brand reputation service according to one embodiment of the present invention. This example illustrates a process as my be performed by the system illustrated and described above with reference to FIG. 4. That is, this example illustrates a process for generating a reputation score for a website. In this example, processing begins with collecting 805 information related to each of a plurality of websites. The information can be related to use of brand information by the website. As noted above, the information related to use of brand information by the website can comprise a wide variety of possible data. Generally speaking, this data can include, but is not limited to data harvested from a plurality of resources, registration data related to the website, data from a plurality of enabling parties, background data related to the brand information, etc.

The collected data related to the website from the collected information can be correlated 810. That is, from the collection of data from various sources, data that is related can be identified and correlated 810. The use of the brand information by the website can then be scored 815 based on the correlated data. As noted above, scoring 815 the website can comprise generating one of a plurality of levels of indicators, wherein each level of the plurality of levels of indicators represents a relative level of authenticity for the website use of the brand information. The score for the website can then be saved 820 for use in responding to request for authentication of brand data used by the website.

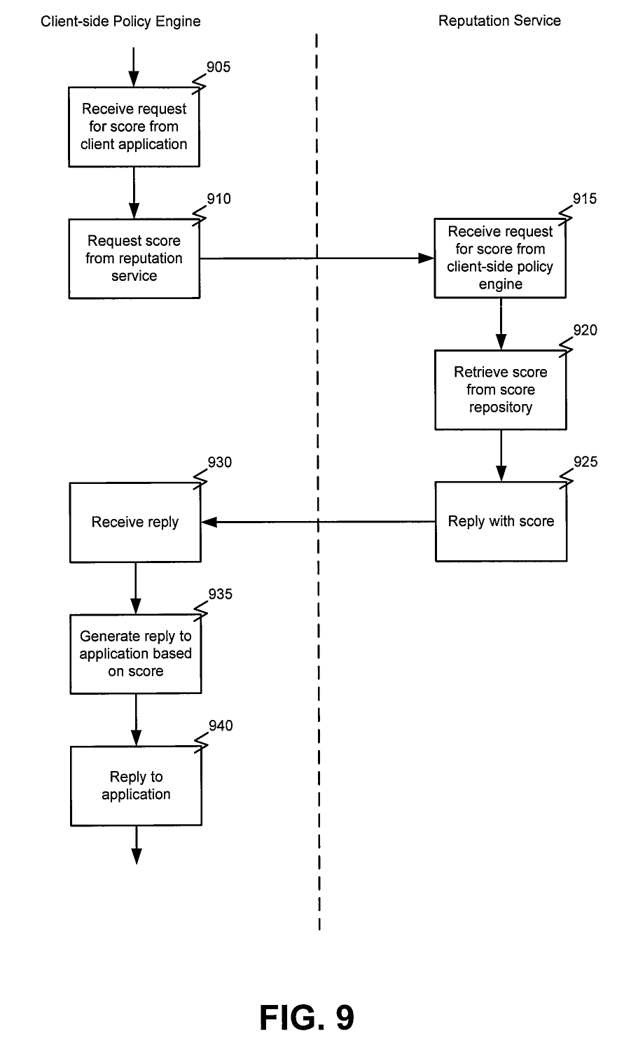

FIG. 9 is a flowchart illustrating a process for a client interaction with a brand reputation service according to one embodiment of the present invention. This example illustrates a process as may be performed by a client side application such as illustrated and described above with reference to FIG. 5. That is, this example illustrates a process for a client making a real-time request to a reputation service. In this example, processing begins with the client-side policy engine or other application as described above receiving 905 a request from a client application for authentication of the brand information used by the web site. As noted above, the client application can be, for example, a web browser, a toolbar application, a security application, etc.

Reputation information related to the website can be requested 910 from a reputation service. As described above, the reputation information can comprise a score indicating the relative authenticity of the brand information used by the website.

The reputation service can receive 915 request from the client-side-policy engine or other application. The reputation service can then retrieve 920 a previously generated and saved score for the website and reply 925 to the client-side policy engine or other application with the score. That is the reputation service can send the score for the website back to the client in response to the request.

The client side policy engine or other application can receive 930 the reputation information from the reputation service and generate 935 a reply to the requesting application based on the score returned by the reputation service. As noted above, the reply can be in the form of one of a plurality of levels, wherein each level of the plurality of levels represents a relative level of authenticity or legitimacy for the website. Alternatively or additionally, a flag or other indicator such a red, yellow, green, level indicator may be provided. Alternatively or additionally, any of a number of messages or warnings may be provided based on the score and the policies of the policy engine.

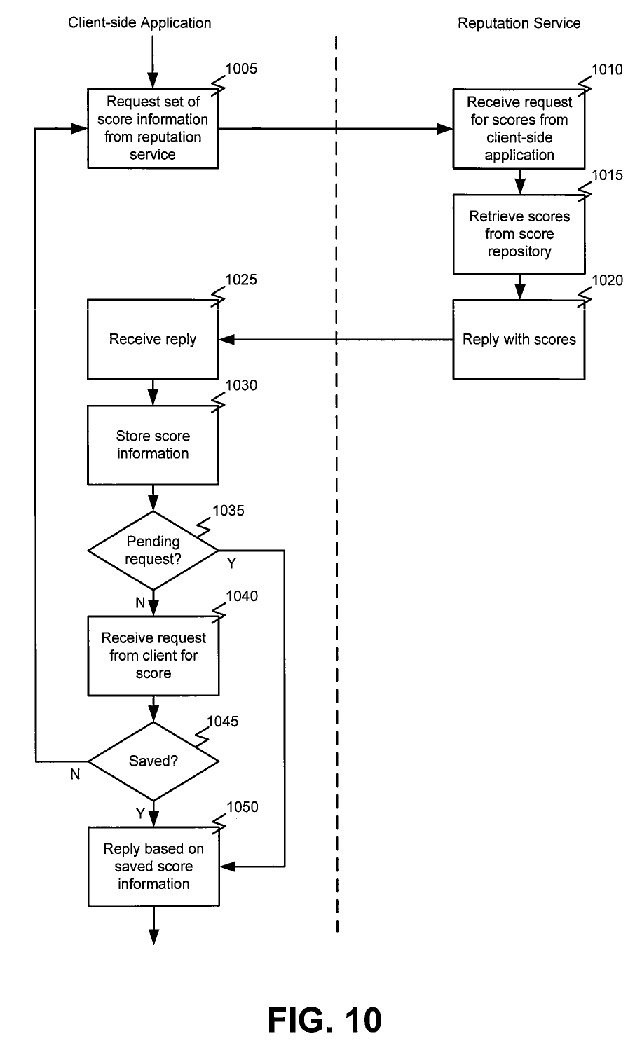

FIG. 10 is a flowchart illustrating a process for a client interaction with a brand reputation service according to an alternative embodiment of the present invention. This example illustrates a process as may be performed by a client side application such as illustrated and described above with reference to FIG. 6. That is, this example illustrates a process for a client making periodic or batch requests to a reputation service. In this example, processing begins with the client-side application, such as a browser or a policy engine, requesting 1005 reputation information related to a website from a reputation service. As described above, the reputation information can comprise a score indicating the relative authenticity of the brand information used by the website.

The reputation service can receive 1010 request from the client-side-policy engine or other application. The reputation service can then retrieve 1015 a previously generated and saved score for the website and reply 1020 to the client-side policy engine or other application with the score. That is the reputation service can send the score for the website back to the client in response to the request.

The client side application can receive 1025 the reputation information from the reputation service and store 1030 the indication of the authenticity of the brand information used by the website. A determination 1035 can be made as to whether there is a pending request for authentication of the website. If 1035 there is a pending request, the client-side application can generate 935 a reply to the requesting application based on the saved score. As noted above, the reply can be in the form of one of a plurality of levels, wherein each level of the plurality of levels represents a relative level of authenticity or legitimacy for the website. Alternatively or additionally, a flag or other indicator such a red, yellow, green, level indicator may be provided. Alternatively or additionally, any of a number of messages or warnings may be provided based on the score and the policies of the policy engine.

If 1035 there is no pending request the client-side application can wait until a new request is received. The client-side application can then receiving 1040 a request from, for example, a web browser, a toolbar application, a security application, etc., for authentication or scoring of a website. The client-side application can determine 1045 if a score has been saved for the requested website. If 1045 a score has previously been saved, the client-side application can reply 1050 based on the saved score. If 1045 a score has not previously been saved, the client side application can request 1005 the score from the reputation service in order to answer the request.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for providing reputation based authentication of brand information used by a website, the method comprising:
collecting information related to each of a plurality of websites, the information related to use of brand information by the website;
correlating information related to the website from the collected information; and
scoring the use of the brand information by the website based on the correlated data.

2. The method of claim 1, further comprising saving the score for the website.

3. The method of claim 2, further comprising:
receiving a request from a client application for reputation information related to the website;
retrieving the saved score for the website; and
providing the saved score to the client application in response to the request.

4. The method of claim 3, wherein said client requests the reputation information in real-time.

5. The method of claim 3, wherein the client periodically requests the reputation information in a batch process.

6. The method of claim 1, wherein the information related to use of brand information by the website comprises data harvested from a plurality of resources.

7. The method of claim 1, wherein the information related to use of brand information by the website comprises registration data related to the website.

8. The method of claim 1, wherein the information related to use of brand information by the website comprises data from a plurality of enabling parties.

9. The method of claim 1, wherein the information related to use of brand information by the website comprises background data related to the brand information.

10. The method of claim 1, wherein scoring the website comprises generating one of a plurality of levels of indicators, wherein each level of the plurality of levels of indicators represents a relative level of authenticity for the website use of the brand information.

11. A method of determining authenticity of brand information used by a website, the method comprising:
requesting reputation information related to the website from a reputation service, wherein the reputation information comprises a score indicating the relative authenticity of the brand information used by the website;
receiving the reputation information from the reputation service; and
generating an indication of the authenticity of the brand information used by the website based on the score.

12. The method of claim 11, further comprising, prior to requesting reputation information related to the website from the reputation service, receiving a request from a client application for authentication of the brand information used by the web site.

13. The method of claim 12, further comprising providing the indication of the authenticity of the brand information used by the website to the requesting client application.

14. The method of claim 12, wherein the requesting client application comprises a web browser viewing the website.

15. The method of claim 11, wherein requesting reputation information related to the website from the reputation service is performed periodically.

16. The method of claim 15, further comprising saving the indication of the authenticity of the brand information used by the website.

17. The method of claim 16, further comprising receiving a request from a client application for authentication of the brand information used by the web site.

18. The method of claim 17, further comprising:
retrieving the saved indication of the authenticity of the brand information used by the website; and
providing the indication of the authenticity of the brand information used by the website to the requesting client application.

19. The method of claim 17, wherein the requesting client application comprises a web browser viewing the website.

20. The method of claim 11, wherein the indication of the authenticity of the brand information used by the website comprises one of a plurality of levels of indicators, wherein each level of the plurality of levels of indicators represents a relative level of authenticity for the website use of the brand information.

21. A system comprising:
a communications network;
a reputation service communicatively coupled with the communications network and adapted to collect information related to each of a plurality of websites, the information related to use of brand information by each of the websites, correlate information related to a website from the collected information, and score the use of the brand information by the website based on the correlated data; and
a client system communicatively coupled with the communications network and adapted to request reputation information related to the website from the reputation service, receive the reputation information from the reputation service and generating an indication of the authenticity of the brand information used by the website based on the score.

22. The system co claim 21, wherein the reputation service is further adapted to save the score for the website.

23. The system of claim 21, wherein the reputation service is further adapted to, in response to receiving the request from the client system for reputation information related to the website, retrieve the saved score for the website and provide the saved score to the client application in response to the request.

24. The system of claim 21, wherein said client requests the reputation information in real-time.

25. The system of claim 21, wherein the client periodically requests the reputation information in a batch process.

26. The system of claim 21, wherein the information related to use of brand information by the website comprises data harvested from a plurality of resources.

27. The system of claim 21, wherein the information related to use of brand information by the website comprises registration data related to the website.

28. The system of claim 21, wherein the information related to use of brand information by the website comprises data from a plurality of enabling parties.

29. The system of claim 21, wherein the information related to use of brand information by the website comprises background data related to the brand information.

30. The system of claim 21, wherein the reputation service is adapted to score the website by generating one of a plurality of levels of indicators, wherein each level of the plurality of levels of indicators represents a relative level of authenticity for the website use of the brand information.

31. The system of claim 21, wherein the client system, prior to requesting reputation information related to the website from the reputation service, receives a request from a client application for authentication of the brand information used by the web site.

32. The system of claim 31, wherein the client system is adapted to provide the indication of the authenticity of the brand information used by the website to the requesting client application.

33. The system of claim 32, wherein the requesting client application comprises a web browser viewing the website.

34. The method of claim 25, wherein the client system is adapted to save the indication of the authenticity of the brand information used by the website.

35. The system of claim 34, wherein the client system is further adapted to receive a request from a client application for authentication of the brand information used by the web site.

36. The system of claim 35, wherein the client system, in response to receiving the request from the client application, is further adapted to:
retrieve the saved indication of the authenticity of the brand information used by the website; and
provide the indication of the authenticity of the brand information used by the website to the requesting client application.

37. The system of claim 36, wherein the requesting client application comprises a web browser viewing the website.

38. The system of claim 37, wherein the indication of the authenticity of the brand information used by the website comprises one of a plurality of levels of indicators, wherein each level of the plurality of levels of indicators represents a relative level of authenticity for the website use of the brand information.
